(19) United States
(12) Patent Application Publication
(10) Pub. No.: US 2014/0179284 A1
(43) Pub. Date: Jun. 26, 2014

(54) TERMINAL AND METHOD FOR TRANSMISSION OF USER INFORMATION

(71) Applicant: Pantech Co., Ltd., Seoul (KR)

(72) Inventor: Ji Young SONG, Seoul (KR)

(73) Assignee: Pantech Co., Ltd., Seoul (KR)

(21) Appl. No.: 14/108,978

(22) Filed: Dec. 17, 2013

(30) Foreign Application Priority Data
Dec. 20, 2012 (KR) 10-2012-0149771

(51) Int. Cl. H04M 1/725; H04W 4/16

(52) U.S. Cl. CPC H04M 1/72569; H04W 4/16
USPC 455/414.1

(57) ABSTRACT

A mobile terminal to provide an interface for user information management includes a display to display a user interface to receive a user input and to receive the user input via the displayed user interface, a wireless transceiver to establish a voice communication channel and to transceive a voice communication signal, and a controller to determine an event for communicating user information and to control the user interface to display the user information. The user information is communicated via the established voice communication channel.

### CROSS-REFERENCE TO RELATED APPLICATIONS

This application claims priority from and the benefit under 35 U.S.C. §119(a) of Korean Patent Application No. 10-2012-0149771, filed on Dec. 20, 2012, which is hereby incorporated by reference for all purposes as if fully set forth herein.

### BACKGROUND

1. Field

The present disclosure relates to a terminal and method for transmission of user information to a caller or a callee, and more particularly to a terminal and method for recognizing a caller or a callee and inputting user information.

2. Discussion of the Background

When a caller makes a phone call to a callee by using a mobile terminal or a callee receives a phone call from a specific caller, a specific serial number, such as a resident registration number, e.g., a social security number, or a card number, e.g., a credit card number, is often requested. For example, when a user makes a call to a customer service center of a communication service provider to receive information, counseling, and the like, the customer service center of the communication service provider may request a resident registration number of the user to verify the identification of the user, and the user provides his resident registration number according to the request.

While the phone call of the user is connected to the customer service center of the communication service provider, the user may expect that user information (for example, his resident registration number, his card number or the like) will be requested in many cases. Thus, the user frequently transmits sensitive user information, such as a resident registration number or a card number, to the caller/callee, and it may cause a leakage of the sensitive user information. Further, it may not be easy for the user to memorize such user information.

Conventional terminals do not provide a function for assisting the user to input user information in a convenient fashion when a phone call is established. For example, users may store personal information, such as card numbers or the like, in a memo application and then execute the memo application to check a specific card number during the phone call. However, it may be risky to save the sensitive user information in the memo application.

FIG. 1 is a diagram illustrating an example of executing an application in order to check user information during a phone call according to the related art. Referring to FIG. 1, a user executes a memo application during a phone call, checks or views a card number and then speaks the card number checked in the memo application to the requester. The user may input the card number by using a dial pad.

If a card number is checked according to the above method, the user needs to inconveniently execute a separate application during the phone call, to memorize or write down the numbers recorded in the memo application, and input the numbers one by one using a dial pad.

Further, if the user directly speaks the user information, such as the card number, in a public place, there is a risk of theft or misuse of the user information.

### SUMMARY

Exemplary embodiments of the present invention provide a terminal and method for communicating user sensitive information with enhanced security and convenience. According to aspects, the terminal may provide complex user information to another terminal securely, in response to a request for the sensitive user information.

According to aspects, complex user information may be conveniently transmitted to the requester while securely protecting the sensitive user information.

Additional features of the invention will be set forth in the description which follows, and in part will be apparent from the description, or may be learned by practice of the invention.

Exemplary embodiments of the present invention provide a mobile terminal to provide an interface for user information management, including: a display to display a user interface to receive a user input and to receive the user input via the displayed user interface; a wireless transceiver to establish a voice communication channel and to transceive a voice communication signal; and a controller to determine an event for communicating user information and to control the user interface to display the user information, the user information being communicated via the established voice communication channel.

Exemplary embodiments of the present invention provide a method for providing an interface for user information management, including: displaying a user interface to receive a user input and receiving the user input via the displayed user interface; establishing a voice communication channel and transceiving a voice communication signal; and determining an event to communicate user information and controlling the user interface to display the user information, the user information being communicated via the established voice communication channel.

Exemplary embodiments of the present invention provide a non-transitory computer-readable recording medium including an executable program for instructing a computer, when executed by the computer, to perform: displaying a user interface to receive a user input and receiving the user input via the displayed user interface; establishing a voice communication channel and transceiving a voice communication signal; and determining an event to communicate user information and controlling the user interface to display the user information, the user information being communicated via the established voice communication channel.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating an example of executing an application, such as a memo application, in order to check user information, such as a card number, during a phone call according to the related art.

FIG. 2 is a diagram showing a terminal to transmit user information according to an exemplary embodiment of the present invention.

FIG. 3A, FIG. 3B, FIG. 3C, and FIG. 3D are diagrams showing a terminal to transmit user information, which includes a user information input unit according to an exemplary embodiment of the present invention.

FIG. 4A is a diagram showing a user information input unit, which displays user information according to an exemplary embodiment of the present invention.

FIG. 4B is a diagram showing a terminal display unit, which transmits user information to a text to speech (TTS) unit according to an exemplary embodiment of the present invention.

FIG. 5 is a diagram illustrating a process of checking a password in order to transmit user information according to an exemplary embodiment of the present invention.

FIG. 6 is a flowchart illustrating a method for transmission of user information according to an exemplary embodiment of the present invention.

FIG. 7 is a flowchart illustrating a method for transmission of user information according to an exemplary embodiment of the present invention.

FIG. 8 is a flowchart illustrating a method for transmission of user information with an encryption operation according to an embodiment of the present invention.

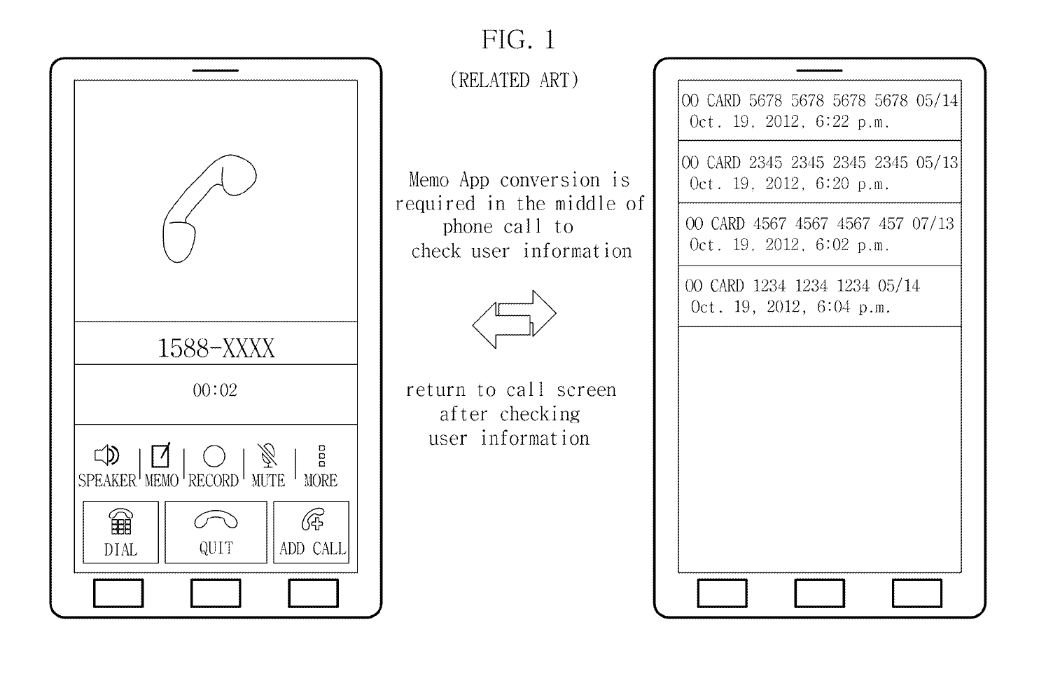

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. Throughout the drawings and the detailed description, unless otherwise described, the same reference numerals will be understood to refer to the same respective elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the specification, the term “unit”, “module” or the like indicates a computer-related entity like hardware, a combination of hardware and software, or software. For example, the term “unit”, “module” or the like used in the specification may be a process, a processor, an object, an executable file, a thread of execution, a program, and/or a computer, without being limited thereto.

In accordance with exemplary embodiments, methods, processes, and/or operations may be illustrated and described as a series of blocks, but the order of the operation blocks may be changed. For example, some operation blocks may be executed simultaneously with other blocks or in a different order from those illustrated and described in the specification, and various diverges, flow paths, block sequences may also be implemented or modified if they generate the equivalent or similar results. In addition, in order to implement the method described in the specification, it is also possible to omit an operation of some operation blocks.

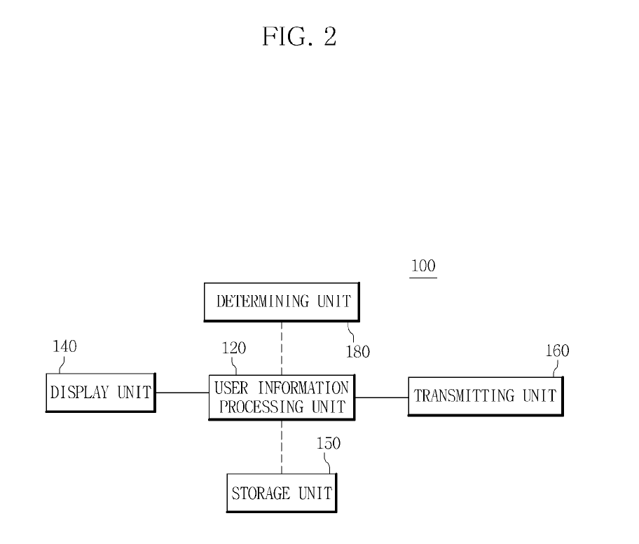

FIG. 2 is a diagram showing a terminal to transmit user information according to an exemplary embodiment of the present invention. Referring to FIG. 2, a user information transmission terminal 100 includes a user information processing unit 120, a display unit 140, and a transmitting unit 160. The user information transmission terminal 100 may further include a determining unit 180 and a storage unit 150.

The user information transmission terminal 100 (“terminal 100”) may be a terminal serving as an information device, such as a personal computer (PC), a portable multimedia player (PMP), a tablet PC, a personal digital assistance (PDA), a smart phone, or the like, which may have a wired or wireless communication with a server. The user information transmission terminal 100 may be an information device having a call function including m-voip.

The terminal 100 may include the display unit 140. The display unit 140 provides visual information by using information received from the user information processing unit 120. The display unit 140 may be a liquid crystal display (LCD), a light emitting polymer display (LPD), an organic light emitting diode (OLED), an active matrix organic light emitting diode (AMOLED) or the like and may include a touch screen function capable of receiving and recognizing a touch input. Further, the terminal 100 may include a communication device and a software communication unit (not shown) capable of making wired/wireless communication with a server.

The transmitting unit 160 may transmit user information, selected by a user from at least one piece of predetermined user information contained in a user information input unit, to a caller or callee connected via a telephone communication.

The terminal 100 may further include a storage unit 150. The storage unit 150 may store a phone number of a user who requests user information and predetermined user information associated with the phone number.

The user information may be a certain type of predetermined information that can be transmitted to a connected caller/callee by the user, and may include any information capable of being transmitted to the connected caller/callee, for example a resident registration number, a card number, a PIN number, a membership number, an account number, a specific word (e.g., his name or birth date) or the like.

The phone number of the user who requests user information may be an automatic response system (ARS) phone number of a customer service center of a card company or a communication service provider, a phone number set by the user (in the case a phone number of a customer service center of a card used by the user is stored in the terminal), a phone number including a specific number (for example, a phone number starting with 1588; 1588-XXXX; 1-800-BBB-HELP; 1-801-CREDIT), and a phone number which has been used for transferring a certain type of user information.

The predetermined user information stored in the storage unit 150 may be stored in association with a phone number. For example, in regard to a phone number of Company A stored in the storage unit 150, a resident registration number, a card number of Company A and a PIN number of Company A may be stored in association with each other. In addition, the storage unit 150 may store use frequency of each user information and use frequency information of user information used in association with a specific phone number.

In a terminal 100, the determining unit 180 may determine whether a call-connected phone number is a phone number of a user or entity who requests user information or previously requested user information.

The determining unit 180 may determine whether a call-connected phone number is a phone number of a user or entity who requests user information or previously requested user information by using the phone number stored in the storage unit 150. More specifically, the determining unit 180 may check whether a call-connected phone number is a phone number of a user who requested user information by searching a phone number of a call-connected caller/callee in the storage unit 150.

Further, the user information transmission terminal 100 may further include a voice receiving unit (not shown) for receiving voice information of a connected caller/callee, and the determining unit 180 may determine whether a call-connected phone number is a phone number of a user who is requesting user information by using the voice information received to the voice receiving unit. The determining unit 180 may determine that the connected caller/callee is requesting a certain type of user information, based on whether the voice received to the voice receiving unit is an automated voice or sound, a machining sound, a mechanical sound, or a standard tone generally used for automatic response system's voice tone, or whether the voice includes a predetermined word. For example, the voice receiving unit receives and recognize a voice signal corresponding to “please enter your credit card number,” the determining unit 180 may determine that the connected caller/callee is requesting the card number as the user information. A voice sound may be an analog or digital voice.

Since an ARS customer service center generally provides a service guidance through an automated voice or sound, e.g., an automated voice or a recorded voice for an automatic response system, instead of directly connecting to a counselor or a customer service representative, the determining unit 180 may determine that the connected caller/callee would request user information by recognizing the automated voice or sound, a mechanical sound or the like. For example, the determining unit 180 may determine that the connected caller/callee would request user information by recognizing the recorded voice, the determining unit 180 may transmit a signal to the user information processing unit 120 to provide an interface to transfer stored user information. Further, it may be determined that a connected caller/callee is requesting user information by recognizing a word “card number”, “resident registration number”, “customer service center” or “user information” from the voice information received to the voice receiving unit. For example, if a connected caller/callee says “please press thirteen digits of your resident registration number”, the phone number of the connected caller/callee may be determined as a phone number of a user who requests or requested user information by recognizing “resident registration number” in the corresponding voice. Such predetermined words may be preset by a device provider or a user. Further, for security purposes, if the connected caller/callee is determined as a scammer based on the previous call record, a blacklisted call number, and the like, the user information processing unit 120 may provide a warning signal, e.g., a message, a voice, and the like, to the user of the terminal 100.

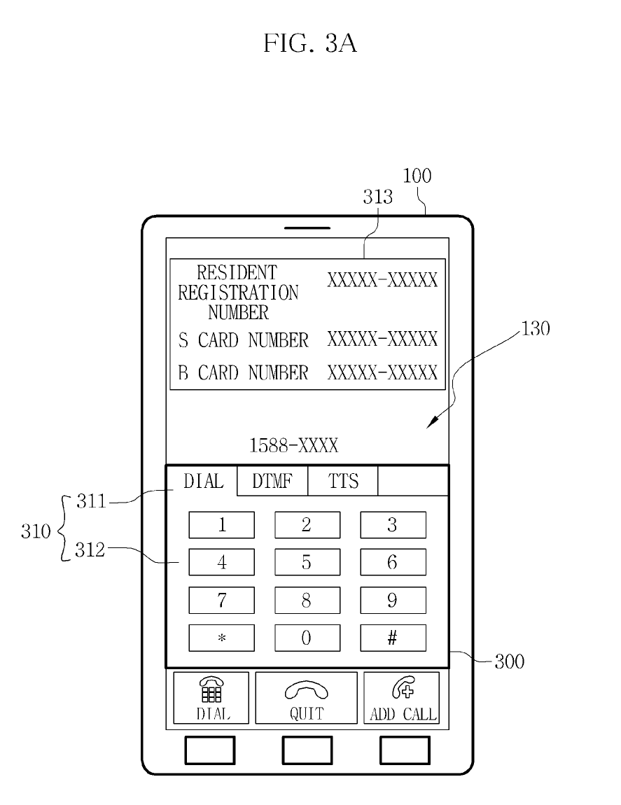

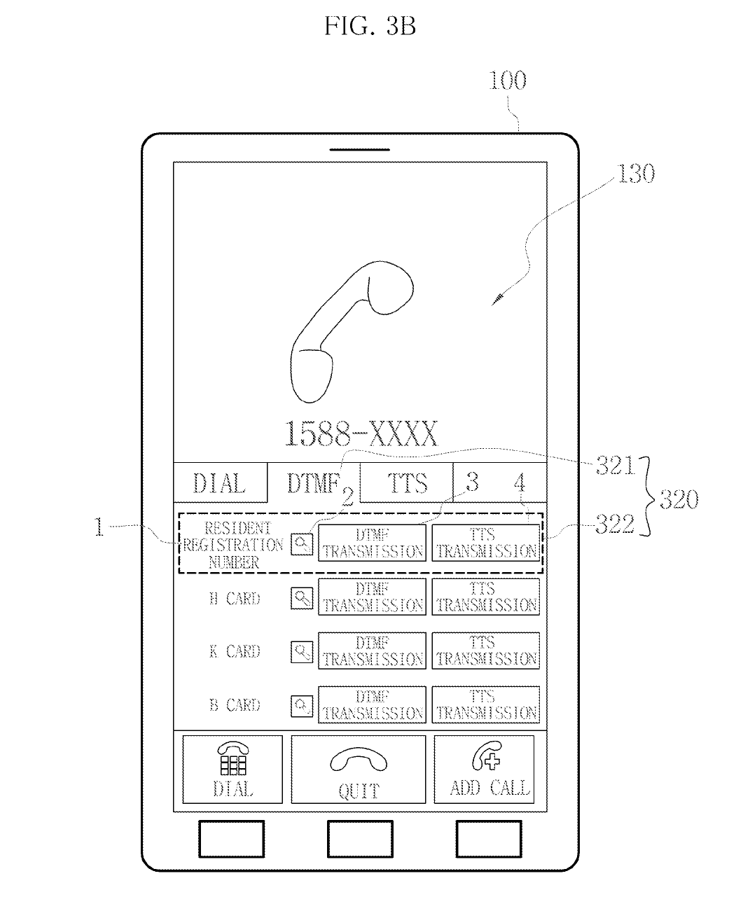

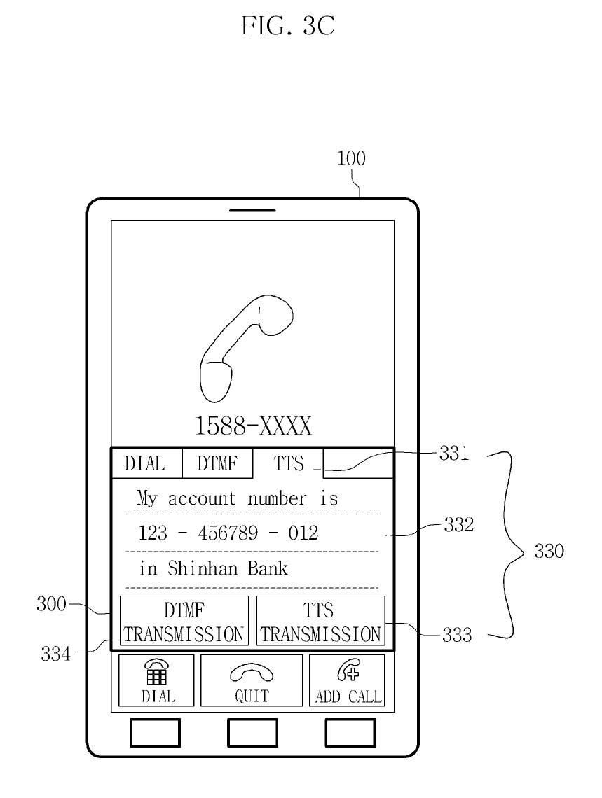

The user information processing unit 120 may execute the user information input unit containing at least one piece of predetermined user information during a phone call. The user information input unit may include a user information providing interface displayed on a touch screen as shown in e.g., FIG. 3A to FIG. 3D. The user information input unit executed by the user information processing unit 120 may be displayed by the display unit 140. The user information input unit may be a kind of an application that may be executed and controlled by the user information processing unit 120 of the user information transmission terminal 100. The predetermined user information may be preset by a user or a terminal provider.

FIG. 3A, FIG. 3B, FIG. 3C, and FIG. 3D are diagrams showing a terminal to transmit user information, which includes a user information input unit according to an exemplary embodiment of the present invention.

FIG. 3A to FIG. 3C show an example of the user information input unit according to an exemplary embodiment of the present invention. The user information input unit may include at least one of a dial unit, a dual tone multi frequency (DTMF) unit, and a text to speech (TTS) unit, which may also be executed simultaneously.

In FIG. 3A to 3C, different states where a user information input unit 300 is executed in a region of the display unit 140 of the terminal 100 are illustrated.

FIG. 3A shows an example of a terminal 100 in which a dial unit 310 is activated as the user information input unit 300. The dial unit 310 may include a number key pad generally used for dialing. Referring to FIG. 3A, the dial unit 310 may include a keypad link 311, e.g., keypad tabs, and a keypad unit 312.

When another user information input unit, such as the DTMF unit 320 or the TTS unit 330, is executed together with the dial unit 310, if the keypad link 311 is selected, the user information processing unit 120 may activate the dial unit 310 to be displayed in a foreground of the display unit 140. As described above, the keypad link 311 functions to activate a selected link on a display screen, and a DTMF link 321 and a TTS link 331 may have the same or similar function. DTMF unit 320 and the TTS unit 330 may be referred to as DTMF interface and TTS interface, respectively.

The keypad unit 312 is a number keypad in which numbers and symbols may be provided as an input interface. A separate manipulation of the keypad 312 or consecutive touches of the numbers while reading user information may be inconvenient for a user to execute the number keypad during a phone call. According to aspects, the number keypad as shown in a terminal screen of FIG. 3A may be provided according to a selection of the user. Further, more convenient functions may be provided as well and be selected by the user. If a user input is received by using the keypad unit 312, the user information processing unit 120 may provide numbers input through the keypad unit 312 to the transmitting unit 160. Then, the transmitting unit 160 may transmit the received numbers to a connected caller/callee.

The dial unit 310 may include a user information display window 313. The user information display window 313 may be displayed in a region of the display unit 140. The user information display window 313 may display predetermined user information, and the displayed user information may be arranged according to user preferences and/or usage frequency of each type of user information based on use history. Also the predetermined user information may be displayed in association with the phone number of the connected caller/callee. Referring to FIG. 3A, since a resident registration number has been transmitted to a phone number 1588-XXXX most frequently, the resident registration number may be located at the top in the user information display window 313 including the predetermined user information.

The user information displayed in the user information display window 313 may be transmitted to a caller/callee in a DTMF format or a TTS format according to the selection of the user. If the user selects the user information displayed in the user information display window 313, the user may select a DTMF format or a TTS format for transmission.

In FIG. 3B, an example of a terminal 100 in which the DTMF unit 320 is activated as the user information input unit 300 is provided.

The DTMF unit 320 includes a DTMF link 321 and a DTMF user information 322. The DTMF unit 320 includes an item corresponding to a series of numbers and allows a user to manipulate a series of numbers simultaneously by using the corresponding item. For example, the DTMF unit represents a component, which makes a series of numbers 123456-1111111 to correspond to the “resident registration number” and stores a series of numbers 1111-2222-3333-4444 corresponding to a “card number”.

Further, the user information processing unit 120 may provide user information, selected by the user from the predetermined user information displayed in the DTMF unit 320, to the transmitting unit 160. To this end, the user information processing unit 120 may convert the user information into a format suitable for the demand of a connected caller/callee and then provide the converted user information to the transmitting unit 160. For example, if the user selects a “card number”, the user information processing unit 120 may provide a series of numbers 1111-2222-3333-4444 to the transmitting unit 160.

Referring to FIG. 3B, the DTMF unit 320 may include a DTMF link 321 and at least one predetermined user information 322. In the DTMF unit 320, the predetermined user information may be displayed as a set including the title 1 of the user information, a preview initiating unit (preview interface) 2 for identifying the content of the user information, a DTMF transmission 3, and a TTS transmission 4.

Referring to FIG. 3B, when the user intends to transmit a resident registration number to the connected caller/callee, if the user selects the preview initiating unit 2, the display unit 140 may display the content of the resident registration number. If the DTMF transmission 3 is selected, the user information processing unit 120 may provide 13 digits of the resident registration number to the transmitting unit 160. The transmitting unit 160 may transmit 13 digits of the resident registration number to the connected caller/callee in a DTMF format. If the TTS transmission 4 is selected, the user information processing unit 120 may convert 13 digits of the resident registration number into a text voice and provides the text voice to the transmitting unit 160. Accordingly, the transmitting unit 160 may transmit the voice information to the connected caller/callee, and the connected caller/callee may receive 13 digits of the resident registration number as a voice. The TTS technique is a text-speech automatic conversion technique, which outputs a user input in a voice form.

In FIG. 3D, an example of the terminal showing a user information displaying method of the DTMF unit is provided. The user information of the DTMF unit 320 may be displayed as an icon as shown in FIG. 3D. Referring to FIG. 3D, if the user information displayed as a single icon is selected, the user information processing unit 120 may generate a menu window 6 for the selected user information and display the menu window 6 on the display unit. The displayed menu window 6 provides a processing method for the selected user information. If the DTMF transmission 7 is selected, the user information processing unit 120 may transmit the content of the selected user information in a DTMF format. If the TTS transmission 8 is selected, the user information processing unit 120 may transmit the content of the selected user information in a TTS format. In addition, if the information display 9 is selected, a window (not shown) for displaying details of the selected user information may be separately generated and displayed.

The user information processing unit 120 may display the predetermined user information in the DTMF unit 320 according to the use pattern of the user. The user information transmission terminal 100 may further include use history information of the predetermined user information. The use history information may include use frequency of the user information and use frequency information of the user information used in association with the phone number.

The user information processing unit 120 may calculate a priority of the predetermined user information by using the use history information and arrange the predetermined user information displayed in the DTMF unit 320 according to the calculated or determined priority. For example, user information most frequently used may be arranged at the top, and user information most frequently used for each phone number may be arranged at the top.

If the predetermined user information shown in FIG. 3B is arranged based on the use frequency information of user information associated with a call-connected phone number, this means that the user transmitted the resident registration number more frequently to the phone number “1588-XXXX”. The transmission or use frequency of user information with respect to the phone number is sorted, and thus the resident registration number is followed by H card, and K card. If the items shown in FIG. 3B are arranged based on use frequency of the user information, this means that the user transmitted the resident registration number more frequently regardless of the phone number. The total transmission or use frequency of user information is sorted, and thus the resident registration number may be followed by H card, K card, and B card.

Further, the user information processing unit 120 may provide a predetermined user information set with respect to a specific phone number. For example, when a call is made to a customer service center of an S card service provider, the user information processing unit 120 may provide a resident registration number, a card number of the S card service provider, his name and a PIN number of Company S, as the predetermined user information.

In addition, the user information processing unit 120 may execute at least one of the dial unit 310 and the TTS unit for receiving a text input, together with the DTMF unit 320. In this case, an additional user information input unit may be executed according to the selection of the user.

In FIG. 3C, an example of the terminal 100 in which the TTS unit 330 is activated as the user information input unit 300 is provided.

The TTS unit 330 is a component for performing a text-speech automatic conversion technique. Even though the terminal 100 receives and displays a user input as a text, the TTS unit 330 may output a voice input corresponding to the text. Reading an input text as an automated voice or sound, or a mechanical sound is also one of TTS techniques.

The TTS unit 330 may include a TTS link 331, a text input unit 332, a TTS transmission 333 and a DTMF transmission 334. The text input unit 332 is a portion where a text is received from a user input and displayed. If the TTS unit 330 is activated, a text input device (not shown, for example, a QWERTY keyboard or the like) may be executed, and the user may input a predetermined text in the text input unit by using the text input device.

The user information processing unit 120 may convert a text (user information) input by the text input unit 332 into voice information (TTS conversion) and provide the voice information to the transmitting unit 160. The transmitting unit 160 may transmit the voice information received from the user information processing unit 120 to the connected caller/callee. Accordingly, the connected caller/callee may listen to a voice corresponding to the text input received in the text input unit.

If the DTMF transmission 334 is selected, the user information processing unit 120 may transmit the text input received in the text input unit 332 to the connected caller/callee in a DTMF format. If a text or number is input in the text input unit 332, the user information processing unit 120 may transmit only numbers in a DTMF format.

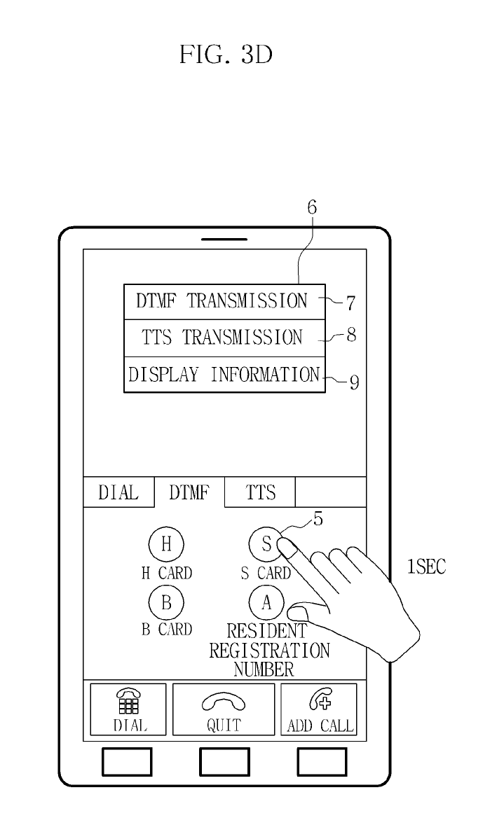

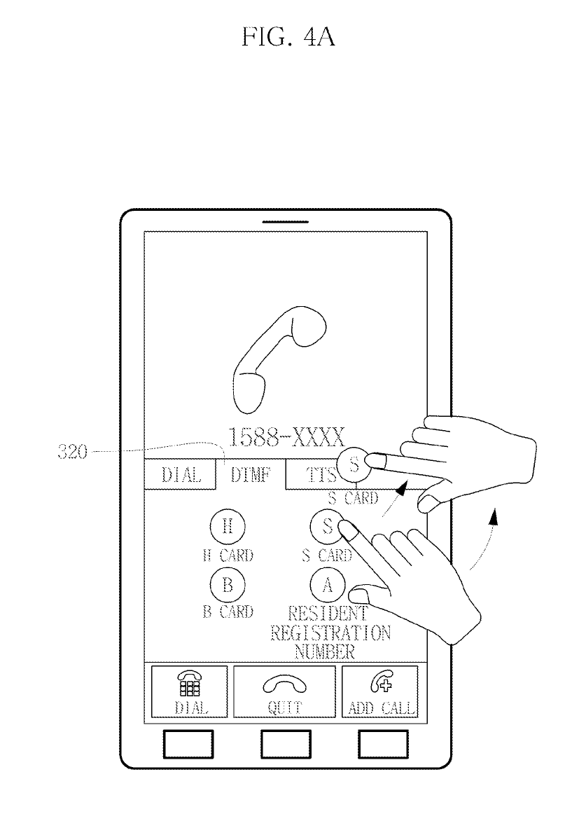

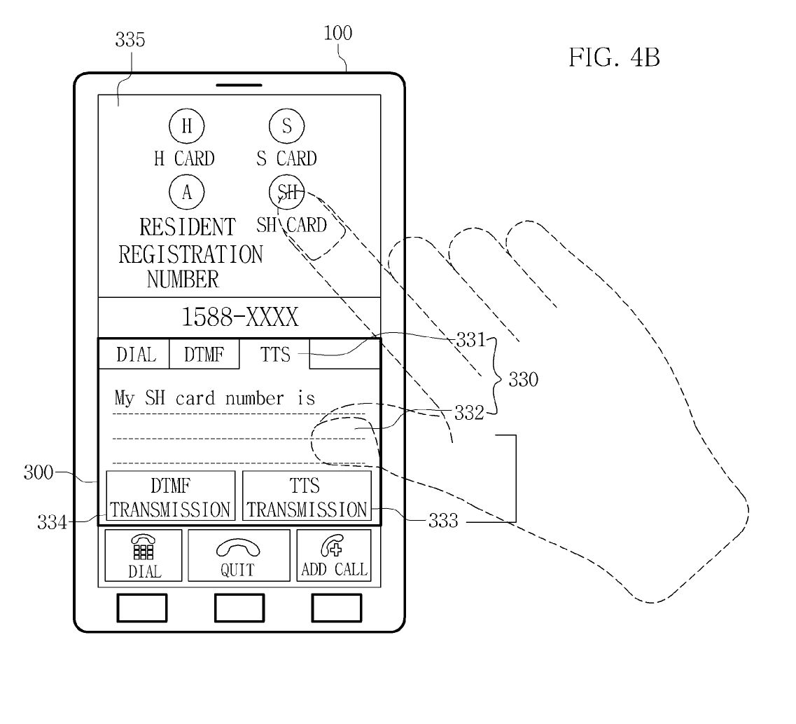

FIG. 4A is a diagram showing a user information input unit, which displays user information according to an exemplary embodiment of the present invention. In FIG. 4A, an example in which predetermined user information included in the DTMF unit is transmitted to the TTS unit and used is illustrated.

The user information processing unit 120 may execute at least one of the dial unit 310 and the DTMF unit 320 together with the TTS unit 330. If the DTMF link 321 is selected in a state where the TTS unit 330 is activated as a foreground, the user information processing unit 120 may move the TTS unit to a background and activate the DTMF unit 320 at the foreground.

FIG. 4A shows a state in which the DTMF unit 320 is activated, in which the predetermined user information is represented by an icon. If an icon representing predetermined user information is moved to the TTS link 330 by the user, the user information processing unit 120 may input user information corresponding to the moved icon at a specific location of the text input unit 332 of the TTS unit 330.

The specific location may be a portion selected by the user in the text input unit 332. For transmitting the predetermined user information to the TTS unit 330, other methods other than the use of the TTS link 330 may be used. Referring to FIG. 3C and FIG. 4A, a card number of an S card may be transmitted to the text input unit 332 by the manipulation of the user.

FIG. 4B shows an example of a preset window 335 including predetermined user information together with the TTS unit 330. Referring to FIG. 4B, pieces of predetermined user information is displayed in a partial region of the display unit 140, and the user may select one piece of the displayed predetermined user information. By using the preset window 335, the user may input specific user information to the text input unit 332 in a simple way. The preset window 335 provides an emoticon menu for input of a text, and similarly the user information processing unit 120 may provide predetermined user information together with the text input unit 332.

Referring to FIG. 4B, if the user selects user information representing a SH card in the preset window 335 in order to input a SH card number, the user information processing unit 120 may input the SH card number to the text input unit 332.

If user information is input by using the TTS unit 330, the user information requiring supplementation may be transmitted to the connected caller/callee as a voice message without speaking to the speaker. However, in some cases, the corresponding user information may be memorized by the user, or another application recording the user information may be executed. Therefore, the above problems may be solved by using the function of the user information processing unit 120 as described above with reference to FIG. 4A and FIG. 4B.

The user information transmission terminal 100 may further include an encryption unit for receiving a password from the user (not shown) and the user information transmission terminal 100, if an accurate password is input, operates the user information processing unit 120. The encryption unit may enhance security of the user information recorded in the terminal 100 by controlling the user information processing unit 120.

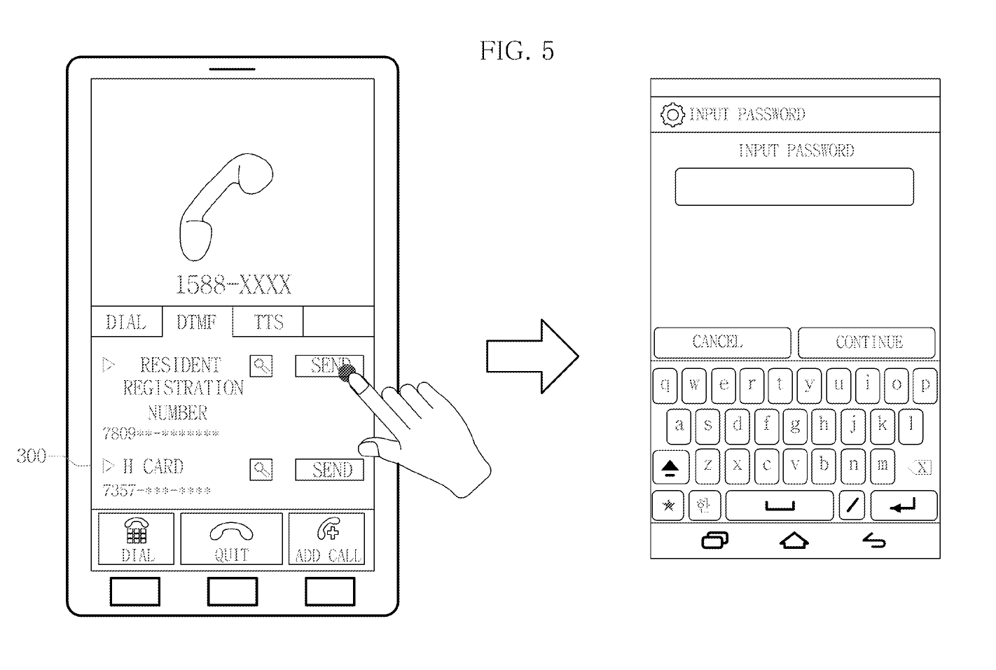

FIG. 5 is a diagram illustrating a process of checking a password in order to transmit user information according to an exemplary embodiment of the present invention. In FIG. 5, an example of a password checking operation before the user information is transmitted is illustrated. The encryption operation may be performed before the user information is transmitted as shown in FIG. 5 or be performed before the user information input unit 300 is executed since a call-connected phone number is checked as a phone number, which requests user information.

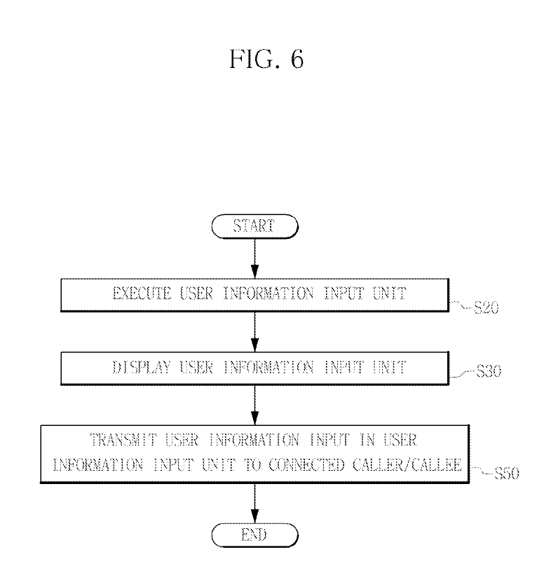

FIG. 6 is a flowchart illustrating a method for transmission of user information according to an exemplary embodiment of the present invention. The method for transmission of user information includes executing a user information input unit containing at least one predetermined user information during a phone call (operation S20), displaying the user information input unit (operation S30), and transmitting user information, selected by a user from at least one predetermined user information contained in the user information input unit, to a connected caller/callee (operation S50).

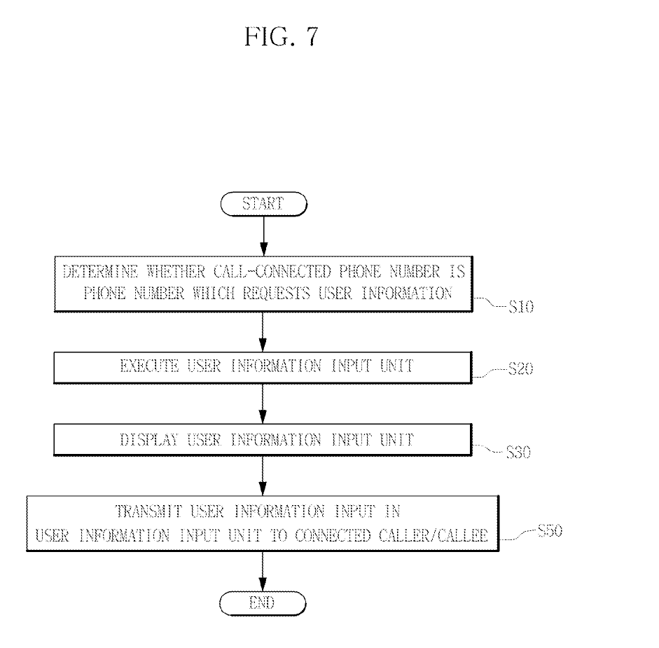

FIG. 7 is a flowchart illustrating a method for transmission of user information according to an exemplary embodiment of the present invention. The method for transmission of user information may further include determining whether a call-connected phone number is a phone number that requests or previously requested user information (operation S10). In the operation S20 of executing a user information input unit to receive user information from a user during a phone call by a user information processing unit, the user information input unit may be executed in response to a determination that the call-connected phone number is a phone number that requests or previously requested user information. Further, the user information input unit may be executed according to the selection of the user.

The method may further include storing a phone number that requests user information and the predetermined user information associated with the phone number that requests user information. Accordingly, phone numbers that requested user information one or more times may be stored and recognized. The phone number and the predetermined user information may be stored in the storage unit of the terminal.

In the determination of whether a call-connected phone number is a phone number that requests user information, it may be possible to determine whether a call-connected phone number is a phone number that requests user information by using the stored phone numbers that previously requested user information one or more times. More specifically, the call-connected phone number may be searched in a list of the phone numbers stored in the storage unit.

The phone number stored in the storage unit may include a specific number pattern. For example, if a phone number includes specific numbers, e.g., “1588” or “800,” the phone number may be determined as a phone number that requests user information. The storage unit may store phone numbers including the specific number pattern as phone numbers generally requesting user information Based on the stored data in the storage unit, the call-connected phone number may be determined as a phone number that requests user information if the call-connected phone number includes or starts with “1588”.

The method for transmission of user information may further include receiving voice information of the connected caller/callee. Further, it may be possible to determine whether a current call-connected phone number is a phone number that requests user information by using the received voice information.

For example, if a received voice call includes a voice and the voice information is an automated voice or sound or includes a predetermined word, the call-connected phone number may be determined as a phone number that requests user information. The predetermined word may be stored in advance as a word to determine whether the connected call requests user information by identifying the word. The terminal may determine the characteristic of the call by extracting the predetermined word from the voice information.

Further, the user information input unit may include at least one of a dial unit, a DTMF unit and a TTS unit, which may be executed simultaneously.

If the user information input unit activates a dial unit, the terminal may receive a number from the user through the dial unit and transmit the received number to the connected caller/callee.

The DTMF unit may display the predetermined user information, and the predetermined user information may include multiple pieces of user information. The terminal may transmit specific user information, selected by the user from the predetermined user information displayed in the DTMF unit, to the connected caller/callee. The selection of the user may be performed by a direct touch or approaching.

The method for transmission of user information may further include storing use history information of the predetermined user information. The user information processing unit 120 may calculate a priority of the predetermined user information by using the use history information and then arrange and display the predetermined user information in the DTMF unit based on the calculated priority. Here, the use history information may include use frequency of the predetermined user information or use frequency of the predetermined user information associated with a specific phone number.

Further, the user information input unit may include at least one of a dial unit and a TTS unit for receiving and displaying a text.

The user information input unit includes a TTS unit, e.g., TTS unit 330, for receiving and displaying a text and may convert a text input in the TTS unit into voice information and transmit the voice information to a connected caller/callee. By using the TTS unit, the user may input a text, and the user information processing unit 120 of the terminal 100 may convert the input text into voice information.

The predetermined user information may be displayed in a partial region of the display unit 140 of the terminal 100. The partial region may be a window containing a plurality of icons. If the user selects predetermined user information displayed in the window, the content of the selected predetermined user information may be displayed as a text by the TTS unit. This operation may be performed by the user information processing unit 120.

The terminal 100 may execute the DTMF unit, e.g., the DTMF unit 320 for displaying predetermined user information together with the TTS unit. If the predetermined user information displayed in the DTMF unit is selected by the user and moved to the TTS unit, the user information processing unit may display the content of the moved predetermined user information as a text in the TTS unit.

The method for transmission of user information may perform an encryption operation. More specifically, the terminal 100 may receive a password from the user if the call-connected phone number is a phone number, which requests user information, and transmits the user information to the connected caller/callee if a correct password is input and verified.

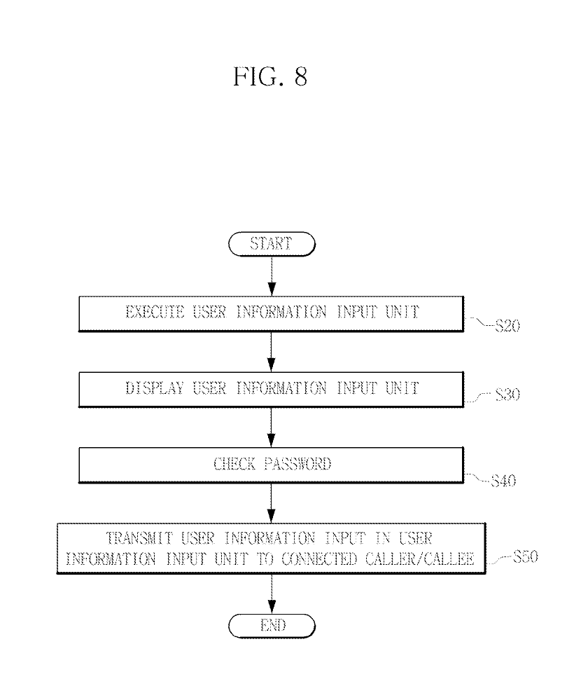

FIG. 8 is a flowchart illustrating a method for transmission of user information with an encryption operation according to an exemplary embodiment of the present invention. Referring to FIG. 8, the method may include executing a user information input unit for receiving user information from a user during a phone call by a user information processing unit (operation S20), and displaying the user information input unit (operation S30). Then, the terminal receives a password from the user. If a correct password is input (operation S40), the user information may be transmitted to a connected caller/callee (operation S50). The password may be checked after the user information input unit is executed and/or the password may be checked before the user information input unit is executed.

In order to enhance security, the user information may be retrieved from a secured storage space that can be connected via wireless connection. Further, the mobile terminal may capture an image of a card number to store the card number as user information. A user may designate a code to encrypt the user information for transmission. This code may be randomly generated or may be set by a user or another entity. If the code is set as 1234 and the user and the connected caller/callee verify the code, user information may be transmitted and stored in a format encrypted by using the code. For example, the code may be added certain digits of the card number and the card number and the code may be separately stored in the terminal 100. The code may be a password set by the user in association with the service center of the corresponding credit card service company or an unlock code of the mobile terminal of the user. However, aspects of the present invention are not limited as such.

The methods according to the above-described exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A mobile terminal to provide an interface for user information management, comprising:
a display to display a user interface to receive a user input and to receive the user input via the displayed user interface;
a wireless transceiver to establish a voice communication channel and to transceive a voice communication signal; and
a controller to determine an event for communicating user information and to control the user interface to display the user information, the user information being communicated via the established voice communication channel.

2. The mobile terminal of claim 1, wherein the user information is retrieved from a storage device, and
the user information comprises at least one of an identification number of a user and a credit card number of the user.

3. The mobile terminal of claim 1, wherein the user interface comprises:
a dual tone multi frequency (DTMF) interface to display a first icon to transmit the user information by a DTMF transmission.

4. The mobile terminal of claim 3, wherein the DTMF interface further displays a second icon to transmit the user information by a text-to-speech (TTS) transmission.

5. The mobile terminal of claim 1, wherein the user interface comprises:
a dual tone multi frequency (DTMF) interface to display an icon of the user information, and
wherein the user information is transmitted via the established voice communication channel according to a selection of the icon.

6. The mobile terminal of claim 5, wherein, if the icon is dragged to a text-to-speech (TTS) interface, the user information is transferred to a portion of the TTS interface.

7. The mobile terminal of claim 5, wherein, if the icon is touched by a user, the display displays a menu for selecting a transmission type of the user information.

8. The mobile terminal of claim 1, wherein the user interface comprises:
a text-to-speech (TTS) interface to display a text input from a user and a TTS transmission icon to transmit voice data corresponding to the text by converting the text into the voice data.

9. The mobile terminal of claim 8, wherein the display displays an icon of the user information and the TTS interface associates the user information for a transmission if the icon and the TTS interface are selected by a user input.

10. The mobile terminal of claim 8, wherein the TTS interface further displays a dual tone multi frequency (DTMF) transmission icon to transmit numbers included in the text according to a DTMF transmission.

11. The mobile terminal of claim 1, wherein the display receives a password to verify a transmission of the user information or to verify a display of the user information, and the controller verifies the password if the password is received.

12. The mobile terminal of claim 1, wherein the user interface is displayed during a phone call after establishing the voice communication channel.

13. The mobile terminal of claim 1, wherein the user interface is displayed during a phone call if a connected phone number corresponds to an entity, the entity determined to request the user information.

14. A method for providing an interface for user information management, comprising:
displaying a user interface to receive a user input and receiving the user input via the displayed user interface;
establishing a voice communication channel and transceiving a voice communication signal; and
determining an event to communicate user information and controlling the user interface to display the user information, the user information being communicated via the established voice communication channel.

15. The method of claim 14, wherein the user information is retrieved from a storage device, and
the user information comprises at least one of an identification number of a user and a credit card number of the user.

16. The method of claim 14, wherein the user interface comprises:
a dual tone multi frequency (DTMF) interface to display a first icon to transmit the user information by a DTMF transmission.

17. The method of claim 14, wherein the user interface comprises:
a dual tone multi frequency (DTMF) interface to display an icon of the user information, and
wherein the user information is transmitted via the established voice communication channel according to a selection of the icon.

18. The method of claim 14, wherein the user interface comprises:
a text-to-speech (TTS) interface to display a text input from a user and a TTS transmission icon to transmit voice data corresponding to the text by converting the text into the voice data.

19. The method of claim 14, further comprising receiving a password to verify a transmission of the user information or to verify a display of the user information.

20. The method of claim 14, wherein the user interface is displayed during a phone call after establishing the voice communication channel.

21. A non-transitory computer-readable recording medium comprising an executable program for instructing a computer, when executed by the computer, to perform the method of claim 14.
